(19) United States
(12) Patent Application Publication
(10) Pub. No.: US 2007/0116922 A1
(43) Pub. Date: May 24, 2007

(54) IDENTIFICATION CARD FORMS

(76) Inventor: Thomas A. Holmberg, Minneapolis, MN (US)

Correspondence Address: FISH & RICHARDSON P.C., PO BOX 1022, MINNEAPOLIS, MN, 55440-1022, US

(21) Appl. No.: 11/626,317

(22) Filed: Jan. 23, 2007

Related U.S. Application Data
(63) Continuation-in-part of application No. 11/266,762, filed on Nov. 3, 2005.
(60) Provisional application No. 60/624,699, filed on Nov. 3, 2004.

(51) Int. Cl. B32B 5/00

(52) U.S. Cl. 428/98

(57) ABSTRACT

A sheetstock including a base sheet including a cut or perforated shaped area that is separable from the base sheet and a film layer adhered to and confined to a top surface of the shaped area is described. The sheetstock may also include embossments and raised areas or bumps. The film layers may be die cut or cut using a laser. Also described are processes for forming a card form in a sheetstock, and processes for forming offset embossments.

### CROSS-REFERENCE TO RELATED APPLICATIONS

This invention is a continuation-in-part of, and claims the benefit under 35 U.S.C. § 120 to, co-pending U.S. patent application Ser. No. 11/266,762, filed Nov. 3, 2005, which claims the benefit under 35 U.S.C. § 19(e) of U.S. Provisional Application No. 60/624,699 filed on Nov. 3, 2004, both of which are hereby incorporated by reference in their entirety.

### TECHNICAL FIELD

This invention relates generally to business forms, and more specifically to identification card forms and other laminated promotional products.

### BACKGROUND

Identification cards and other promotional materials have been printed on xerographic copiers and printers for many years. These cards and other materials have typically been produced by laminating a reinforcing layer of plastic to one or both sides of a paper sheet and then perforating the card shape into the sheet while leaving the film coating the paper sheet in place.

There have been several continuing problems with these products.

One problem is that the film adds thickness to the sheet in only some areas. This causes a stack of the sheets to lie unevenly or have a bias. This stack bias makes it very difficult to feed the form in xerographic or other printing or sorting equipment that need to have a level pile for proper feeding.

A second problem is maintaining consistent throughput during the printing and delivery process, especially in high speed equipment. One reason for this problem is that when a traditional ID card was produced, an oversized strip or patch of film was used to laminate the ID card area. This oversized piece of film increased the chance of the sheet curling, becoming skewed in the paper path or jamming at the various rollers, deflectors and paper directing devices inside the equipment. In general, less film attached to the sheet will produce less curling, static or other feeding issues.

A third problem relates to the method of card production that affects the strength of the card. A steel die has generally been used to cut the film and paper layers to define the ID card shape. This die cut would be made with perforations to allow the card to be removed by the user. However, these perforations also created tiny tears or nicks in the film. During removal of the card these nicks created a starting place for the film to tear causing the card to rip or delaminate. Even after removal of the card, these same nicks can lead to tearing of the card during normal use.

Another issue is the difficulty that some people may have in seeing and removing an ID card or other items from a base sheet stock. This is especially a concern for the elderly or anyone with poor eyesight.

### SUMMARY

In one aspect, a sheetstock is described that includes a base sheet including a cut or perforated shaped area that is separable from the base sheet and a film layer adhered to and confined to a top surface of the shaped area. The shaped area may be integrated with the base sheet as a cut or perforated area of the base sheet.

The sheetstock may also include an area outside the shaped area on a surface of the base sheet having a height at least about the same as a height of the film layer. The area outside the shaped area may include an embossment in the base sheet surface. The embossment may include a ridge around at least a portion of a perimeter of the base sheet, raised bumps, or raised letters or symbols. The embossment may be raised about 0.00075″ to about 0.040″ above the surface of the base sheet. The embossment may have a height at least about the same as a height of the film layer.

The area outside the shaped area may include raised areas of thermography. The raised areas of thermography may have a height about 0.00075″ to about 0.040″ above the surface of the base sheet.

The film layer may be formed in the shape of the shaped area by laser cutting the film layer. The film layer may be adhered to the sheet using a translucent, transparent, or colored adhesive. The film layer may be sufficiently translucent or transparent so that the colored adhesive can be seen through the film layer.

The sheetstock may also include a second film layer adhered to and confined to a bottom surface of the shaped area. The second film layer may be formed in the shape of the shaped area by laser cutting the second film layer.

The film layer may be adhered to the sheet using a colored adhesive, or by using a clear adhesive. The sheetstock may also include a coating on the top surface of the film layer to improve the film's receptivity to ink. The coating on the film layer may be a colored coating.

Variously, the shaped area may have curved edges, more than 4 sides, less than 4 sides, a rectangular shape, the shape of a regular polygon, the shape of an irregular polygon, or the shape of a hanging tag.

In another aspect, a sheetstock is described that includes a base sheet having a grain direction and including a cut or perforated shaped area that is separable from the base sheet, wherein the shaped area has more than one straight edge, and a film layer adhered to and confined to a top surface of the shaped area, wherein the shaped area is located such that each of the straight edges forms an angle of 0 degrees to about 75 degrees relative to the grain direction of the base sheet.

The shaped area may be located such that each of the straight edges forms an angle of 0 degrees to about 60 degrees relative to the grain direction of the base sheet, or the shaped area may be located such that each of the straight edges forms an angle of 0 degrees to about 45 degrees relative to the grain direction of the base sheet.

The sheetstock may also include an area outside the shaped area having a height at least about the same as a height of the film layer. The film layer may be adhered to a top surface of the shaped area using an adhesive including a colorant.

In another aspect, a process for forming a card form in a sheetstock is described that includes cutting or perforating a base sheet to form a shaped area that is separable from the base sheet, adhering a film layer to a surface of the base sheet, and cutting or perforating a film layer to confine the film layer to the shaped area to form a card form in a sheetstock.

The film layer may be cut using a laser beam. The process may include adhering the film layer to the base sheet, and may also include using an adhesive including a colorant to adhere the film layer to the base sheet, or may include using a clear adhesive to adhere the film layer to the base sheet. The process may include adhering a second film layer to another surface of the base sheet, and cutting or perforating the second film layer to confine the second film layer to the shaped area using a laser beam. The second film layer may be cut using a laser beam. The base sheet may be cut or perforated prior to applying the film layer to the base sheet. The process may include removing the first film layer not within the shaped area, or removing the second film layer not within the shaped area.

The process may include embossing an area of the base sheet to have a height at least about the same as the film layer. The process may include embossing a second area that is offset from the first embossed area such that when a sheetstock including the first embossed area is stacked with a sheetstock including the second embossed area the embossed areas do not nest together. The base sheet may be cut to produce a number of sheetstocks. The process may include a base sheet having the first embossed area and the second embossed area, or the process may include a first base sheet having the first embossed area and a second base sheet having the second embossed area.

In another aspect, a process for forming a card form in a sheetstock is described that includes cutting or perforating a base sheet to form a shaped area that is separable from the base sheet, and adhering a film layer to the base sheet, wherein the film layer is confined to the shaped area to form a card form in a sheetstock. The process may include removing the film layer from the base sheet outside the shaped area

In another aspect, a process for forming a card form in a sheetstock is described that includes applying a first film layer to a first surface of a base sheet, cutting or perforating the film layer and base sheet to form a shaped area that is separable from the base sheet while also placing a registration mark, applying a second film layer to a second surface of the base sheet, and using the registration mark for positioning to cut the second film layer. The process may also include removing the first film layer not within the shaped area, or removing the second film layer not within the shaped area.

The process may include embossing an area of the base sheet to have a height at least about the same as the film layers. The process may include embossing a second area that is offset from the first embossed area such that when a sheetstock including the first embossed area is stacked with a sheetstock including the second embossed area the embossed areas do not nest together. The base sheet may be cut to produce a number of sheetstocks. The process may include a base sheet having the first embossed area and the second embossed area, or the process may include a first base sheet having the first embossed area and a second base sheet having the second embossed area. Embossing an area of the base sheet may include embossing an embossed area in one sheetstock that is offset from the embossed area in an adjacent sheetstock such that the embossed areas do not nest together when the sheetstocks are stacked together.

Variously, the registration mark may be placed on the first film layer, or the registration mark may be placed on the base sheet. Variously, the registration mark may be an ink mark, a hole, or an embossment or indentation. Cutting or perforating and placing a registration mark may be done using a die.

As used herein, the term confined means that the film layer will be generally present on a sheetstock only within the perimeter of a shaped area, such that the shaped area may still be easily separated from the sheetstock. Thus, confined would also include instances of small overlapping film areas slightly outside the shape area due to slight processing misalignment, etc.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a top view of one embodiment of a sheetstock including card forms.

FIG. 2 shows a perspective view a portion of the sheetstock of FIG. 1.

FIG. 3 shows a side view of one embodiment of two stacked sheetstocks.

FIG. 4 shows a top view of one embodiment of a sheetstock including card forms.

FIG. 5 shows a top view of one embodiment of a sheetstock including card forms.

FIG. 6 shows a top view of one embodiment of a sheetstock including card forms.

FIG. 7 shows a top view of one embodiment of a sheetstock including card forms.

FIG. 8 shows a side view of the sheetstock of FIG. 7.

FIG. 9 shows a top view of one embodiment of a sheetstock including card forms.

FIG. 10 shows a top view of one embodiment of a sheetstock including card forms.

FIG. 11 shows a side view of the sheetstock of FIG. 10.

FIG. 12 shows a top view of the sheetstock of FIG. 10, during production.

FIG. 13 shows a side view of the sheetstock of FIG. 12 being laser cut.

FIG. 14 shows a top view of one embodiment of a sheetstock including multiple card forms.

FIG. 15 shows a top view of one embodiment of a sheetstock including a card form having a circular shape.

FIG. 16 shows a top view of one embodiment of a sheetstock including a card form in the shape of a hanging tag.

FIG. 17 shows a top view of one embodiment of a sheetstock including a card form having a star shape.

FIG. 18 shows a top view of one embodiment of a sheetstock including a card form having an octagon shape.

FIG. 19 shows a top view of one embodiment of a sheetstock including a card form having an oval shape.

Like reference symbols in the various drawings indicate like elements.

### DETAILED DESCRIPTION

Identification cards and other promotional materials may be producing using a base sheet and a film layer adhered to at least a portion of the sheet. A card form may be formed in the base sheet and film layer. The card form may be removed at a later time from the base sheet. Thus, these card forms are examples of integrated cards, rather than affixed cards or tipped on cards. Processing of integrated cards can provide cost savings and superior results in printing equipment compared with other approaches. In one embodiment, a sheetstock including a card form or other promotional material may be formed from a base sheet and a film layer, distributed to consumers, and then the consumer may detach the formed card form or other promotional material from the sheetstock.

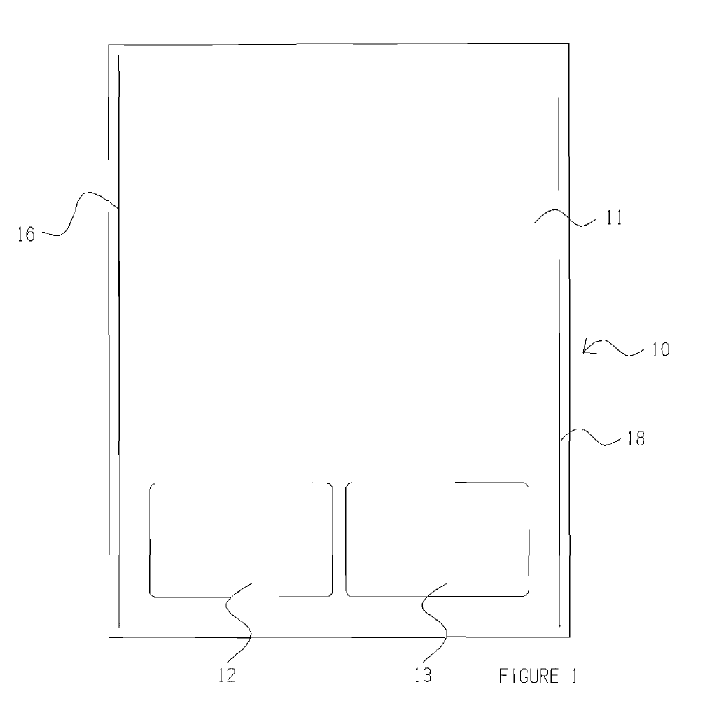

FIG. 1 shows a top view of one embodiment of a sheetstock including card forms (may be one or more card forms). Sheetstock 10 includes a base sheet 11, with card forms 12, 13 defined in the base sheet 11. In one embodiment, the base sheet 11 may be a sheet of 8½″×11″ paper The card forms 12, 13 may include a film layer over the area of the base sheet 11 defined by the card forms 12, 13. This may also be referred to as a shaped area. Generally, the film layer may be ½ to 2 mils thick, though other thicknesses are possible. The film layer may be formed of a plastic material, such as Polyethylene Terephthalate (“PET”), Polycarbonate, Polypropylene, Acetate, or other materials.

In one example, the card forms 12, 13 may be formed by applying a layer of plastic material to the upper side of the base sheet 11 in the area of the cards, and then perforating the card shape into base sheet 11 and the plastic layer to form a shaped area. In another example, the card forms 12, 13 may be formed by applying a layer of plastic material to the upper side and the bottom side of the base sheet 11 in the area of the cards, and then perforating the card shape into base sheet 11 and the plastic layer. In another example, the plastic material can be pre-cut into the shape of the card forms 12, 13 and adhered onto base sheet 11 to define the card forms 12, 13. In another example, discussed in greater detail below, the plastic material may be laser cut and the paper sheet may be perforated by die-cutting. The film layer may be adhered to and confined to a surface of the shaped area. After cutting, the excess film may be removed from the base sheet. The film layers over the card forms may be securely adhered or laminated to the card forms using time (for a slow-acting adhesive), pressure (for a pressure sensitive adhesive), heat (for a heat-sensitive adhesive), light (for a light cured adhesive, such as UV or IR curing) or other appropriate adhesives and methods.

In one embodiment, a film layer may be applied to a base sheet, and the combination cut using a steel die to form a shaped area having a perforated edge. At the same time, another portion of the steel die is used to place a registration mark. Generally, perforation may be accomplished by various means, including by using a rotary die, a reciprocating die, a laser cutter, or other approaches. The registration mark may be placed on the film layer, on the base sheet, or on the base sheet such that it remains after the excess film not in the shaped area is removed from the base sheet. In one embodiment, a raised area of the steel die may be coated with ink, which then places a small dot (e.g., a registration mark) on the base sheet when the shaped area is formed. After a second film is placed on the other side of the base sheet, the registration mark is used to position the laser beam for cutting. Because the dot was printed at the same time the shaped area was formed, the dot is always in the same position relative to the shaped area. Thus, even if the shaped area changes position on the base sheet, the registration mark allows correct positioning for cutting the second film. The second film may be cut using a laser beam or other method. After cutting, the excess second film may be removed. Other approaches for forming a registration mark may be used, such as using ink only visible under certain types of light (such as UV or IR), making an indentation or embossment in the base sheet, making a small hole in the base sheet, or other approaches.

In one embodiment, rather than cutting the film as it lays on the sheet stock, the first and/or second film layer may lie on a belt that runs at the same speed as the paper web with the paper web. During the cutting of the paper web, a registration mark is placed on the paper. The first and/or second film layers may be cut using the registration mark to control the location of the cutting. The system would see the printed dot and fire the laser to cut the film, however the film would be cut as it lies on the belt. Following cutting, the film matrix would be removed and the belt with the shape on it would come into contact with the paper, thus applying the cut film shape in the exact location required. The film shape may be held in place with vacuum, weak contact adhesive, or other means during cutting and placement. The belt used for transporting the film layer may be formed of steel, rubber, synthetic fiber, or other material, and may be driven by gears, servo motors, or other methods. In addition to applying to individual paper sheets, the method may be used in conjunction with a paper web fed from paper rolls.

Sheetstock 10 also includes one or more ridges or embossments 16, 18, which may help solve the problem of an uneven stack of sheetstock. In one example, two embossments 16, 18 run lengthwise along the sheet and are located from about ⅛″ to about ½″ from each outside lengthwise edge of the sheet, and each end of the embossments 16, 18 may be from about 0.1″ to about 1.0″ from the edge of the base sheet 11. In general, the embossments 16, 18 may run the entire length of the base sheet 11, or some portion thereof. In various embodiments, the embossments may run along the entire perimeter of the sheet, or may run along three edges of the sheet. In general, the embossments may be located various distances from the edge of the sheet. In some embodiments, the embossments may also be in the body of the sheet in areas that do not interfere with the printed copy.

The embossments can have a variety of shapes but generally will be dots or lines that may be about 0.020″ to 0.040″ wide and can be up to 11″ long, or as long as the sheet, if over 11″. Other widths of embossments may also be used. The embossments may also be patterns, such as alternating dots and dashes, particular sequences, or other configurations.

In various embodiments, the embossments 16, 18 may project from about 0.0001″ to about 0.05″ from the sheet surface. In one embodiment, the embossments can project approximately 0.00075″ to 0.040″ from the sheet surface. In one embodiment, the embossments may project approximately 0.00075″ to 0.0015″ from the sheet surface.

The embossments may be spaced on every other sheet so that the embossments do not nest into each other in a stacked pile of sheets. For example, every other sheet could have embossments about 1/16″ over horizontally from the previous and following sheets. In another example, the distance of the embossments from the edges of the sheet may alternate from one sheet to the next. The embossments may serve to support and space the sheetstock in the areas of the sheets that do not have the reinforcing plastic film of the card forms 12, 13. Typically, when pages having alternating embossments (or otherwise non-nesting embossments) are stacked together, the resulting stack of sheets lies flat and can be fed easily in standard xerographic equipment or other printing or processing equipment. The embossments may create separation between the sheets allowing better feeding into a copier or printer. The embossments may create separation between the sheets allowing improved handling following printing or copying operations. The embossments may be used for identification or design purposes, as described below.

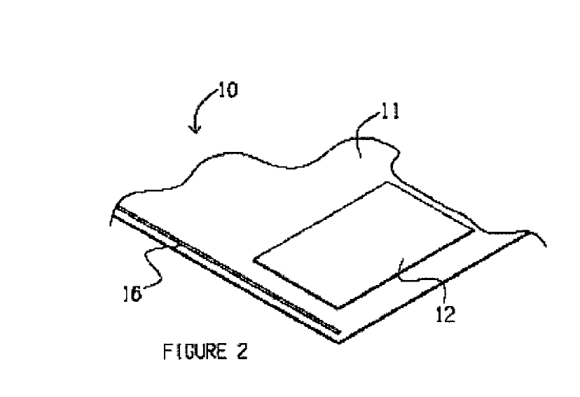

FIG. 2 shows a perspective view a portion of the sheetstock of FIG. 1. This view shows embossment 16 rising above the surface of base sheet 11 to approximately the same height as the plastic film of card 12. In another example, if there is a plastic film of equal thicknesses on both sides of the base sheet 11, then the embossment may be about twice as high as the thickness of a single plastic film.

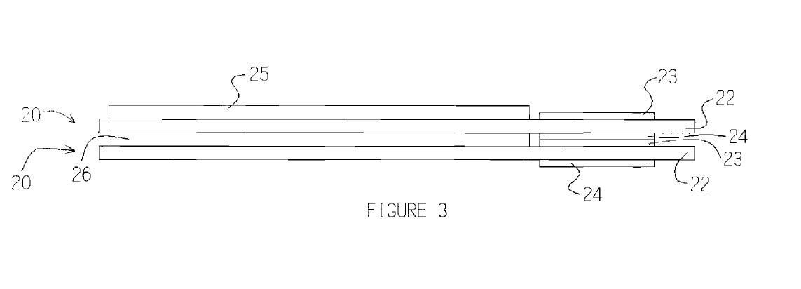

FIG. 3 shows a side view of one embodiment of two stacked sheetstocks. A pair of stacked sheetstocks 20 is shown, each sheetstock 20 having a base sheet 22, and having a plastic film layer 23, 24 on both sides of the sheet in the area of the card forms. In this embodiment, the embossments 25, 26 have about the same height as the total height of both film layers 23, 24. Usually, the film layers 23, 24 have the same thickness; therefore the embossments 25, 26 also typically have twice the height of the film layer 23 or the film layer 24. In one embodiment, for example, the film layers 23, 24 may have a thickness from ½ to 2 mils, and thus, each embossment 25, 26 maybe between 1 and 4 mils high. The pair of base sheets 22 are shown stacked in FIG. 3 to illustrate how the sheets may stack evenly as the embossments 25, 26 heights are equal to the height of both plastic films 23, 24.

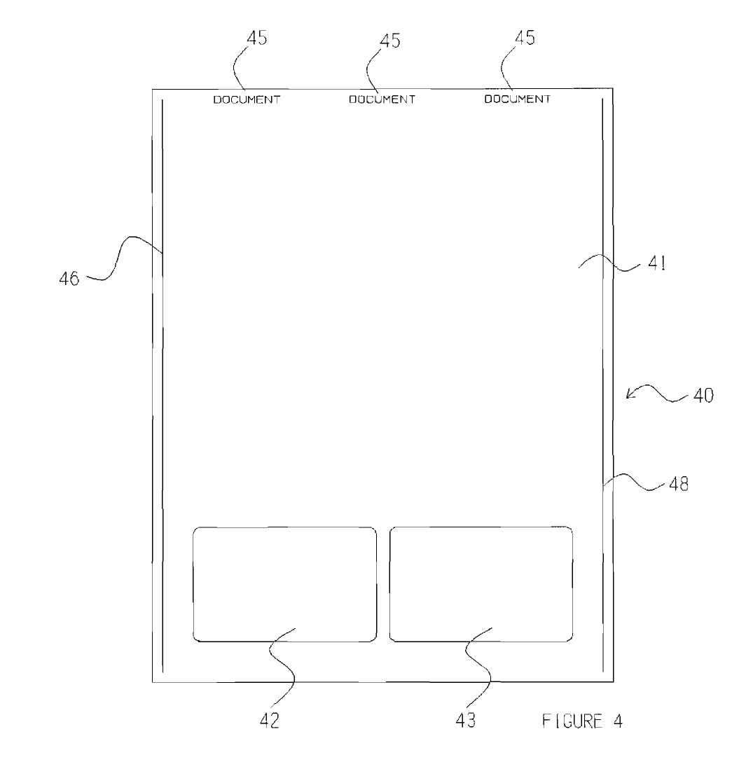

FIG. 4 shows a top view of one embodiment of a sheetstock including card forms. Sheetstock 40 can include any features of the sheetstocks discussed above, such as embossments 46, 48 formed in the base sheet 41. The base sheet 41 may also include one or more card forms 42, 43. In this example, a further embossment is provided by one or more embossments 45 which can form a name, design, logo, symbol, or other pattern or text in the base sheet 11. In various embodiments, the embossments 45 may project from about 0.0001″ to about 0.05″ from the sheet surface. In one embodiment, the embossments 45 can project approximately 0.00075″ to 0.040″ from the sheet surface. In one embodiment, the embossments 45 may project approximately 0.00075″ to 0.0015″ from the sheet surface. The embossments 45 may be raised about 0.00075″ to about 0.040″ above the surface of the base sheet 11. The embossments 45 may be same or different height or width than embossments 16, 18. If film layers are used, the embossments 45 may be the same or different height than the thickness of one or more film layers used with card forms 42, 43. Thus, in some embodiments, embossments 45 may help solve the stacking problem discussed above. In addition, embossments 45 provide a method to add a customer name, logo, etc., or even a security feature to sheetstock 40. In some embodiments, the embossments 45 may be enhanced further by a combination of printing and embossing the name, design, logo, symbol, or other pattern or text selected.

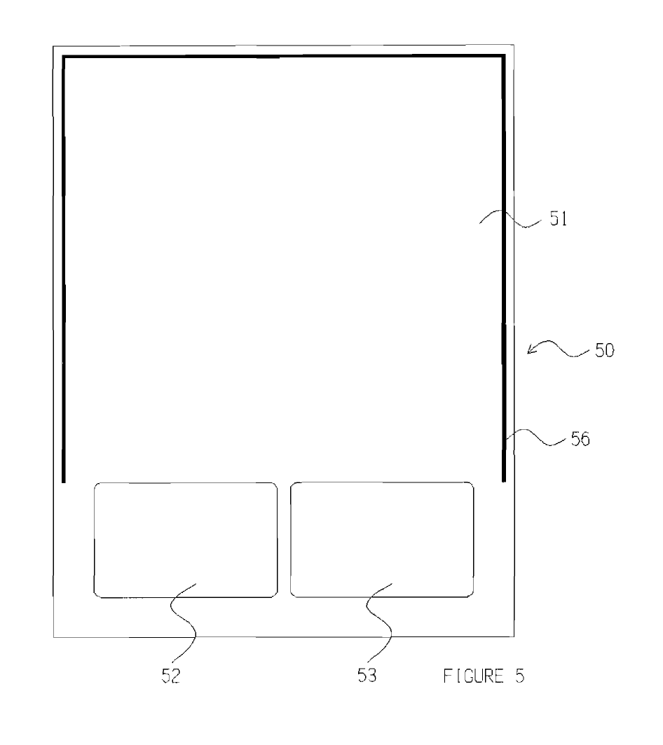

FIG. 5 shows a top view of one embodiment of a sheetstock including card forms. Sheetstock 50 includes a base sheet 51, and may include any features of any sheetstock discussed above, such as card forms 52, 53. In this embodiment, a raised area 56 is formed on base sheet 51 by a technique known as thermography. In thermography, the base sheet is first printed with colored or clear ink in positions where a raised surface is desired. This printing may be accomplished by various processes, including via wet or dry offset or letterpress printing. Thermography powder is added to the base sheet 51 on top of the printing, and the thermography powder adheres to the printed areas. Then, the base sheet 51 with attached thermography powder is heated. The application of heat causes the thermography powder to melt, expand, and fuse to the base sheet 51. By adjusting the amount and type of powder, the height of raised area 56 is determined and controlled. The height of raised area 56 may be a range of heights, such as from about 0.0001″ to about 0.05″ in height, or approximately 0.00075″ to 0.040″ in height from the sheet surface. In one embodiment, the raised areas may have a height of approximately 0.00075″ to 0.0015″. Typically, the height of raised area 56 maybe about the same as film layers used to cover card forms 52, 53 in the sheetstock 50.

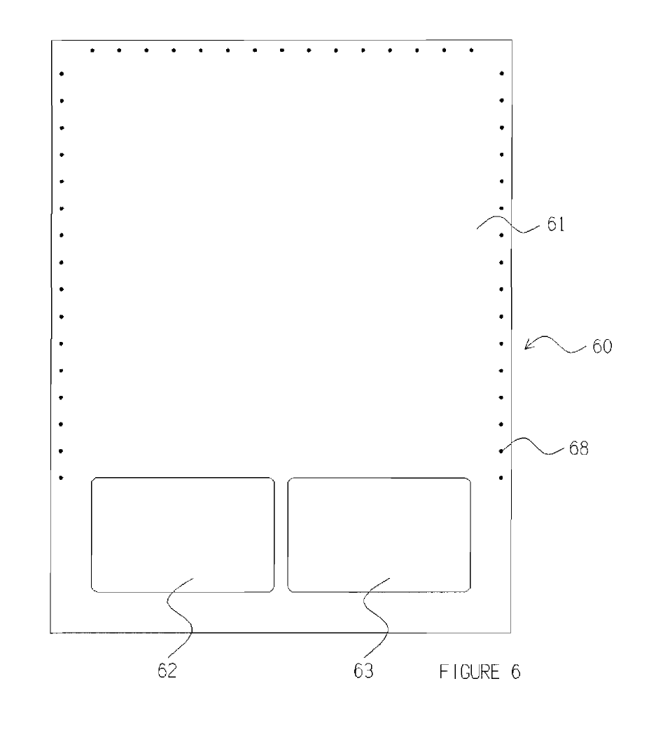

FIG. 6 shows a top view of one embodiment of a sheetstock including card forms. Sheetstock 60 includes a base sheet 61, and may include any features of any sheetstock discussed above, such as card forms 62, 63. In the embodiment shown, the embossment includes a plurality of raised bumps 68 extending around at least a portion of the perimeter of the base sheet 61. The raised bumps 68 can extend along one or more sides of the sheet, including along the top and bottom of the sheet, if desired. The card forms 62, 63 may be formed by cutting the card shapes out of the base sheet 61, and may include a film layer over the card forms. The raised bumps may have a range of heights, such as from about 0.0001″ to about 0.05″ above the base sheet. In one embodiment, the film layer may have a thickness of about ½ to 2 mils, and raised bumps 68 may have a height of about 0.00075″ to about 0.040″ above the surface of the base sheet 61. In one embodiment, the height of the raised bumps 68 may be about the same as the thickness of the film layer used, enabling even stacking of sheetstock, and avoiding the problem with uneven stacking discussed above.

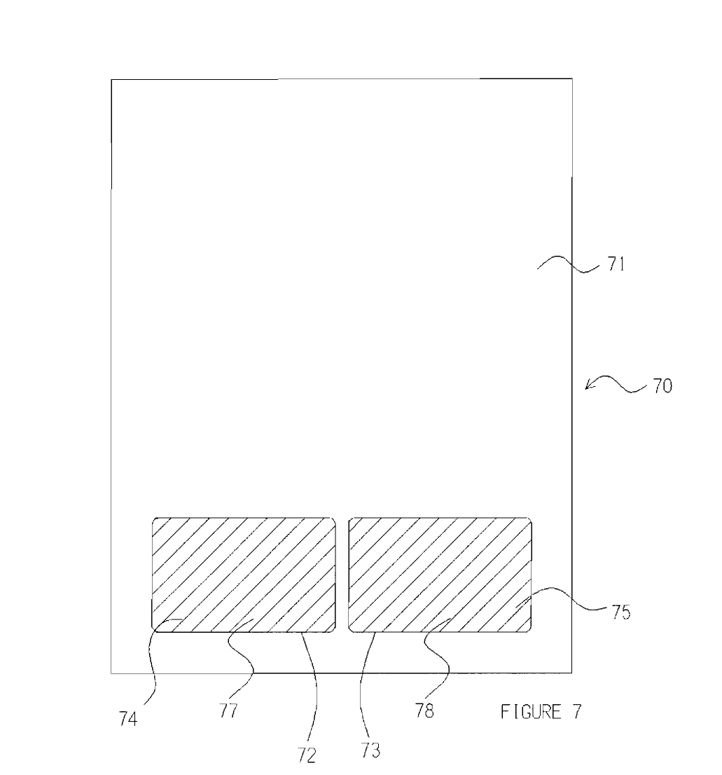

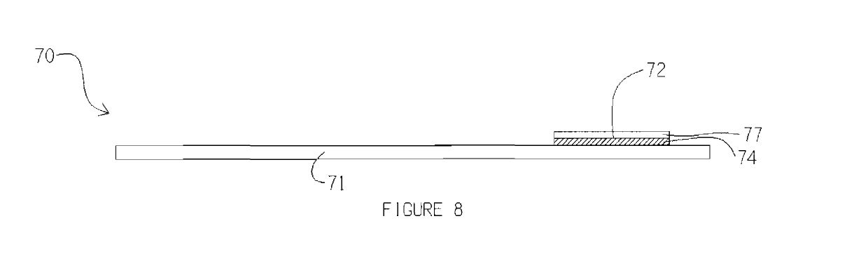

FIG. 7 shows a top view of one embodiment of a sheetstock including card forms. FIG. 8 shows a side view of the sheetstock of FIG. 7. These figures show a sheetstock 70 including a base sheet 71 having card forms 72, 73. The card forms 72, 73 are formed by a portion of the base sheet 71, and film layers 77, 78. The film layers 77, 78 are applied to the base sheet 71 using adhesive layers 74, 75. In one embodiment, the adhesive layers 74, 75 include a colorant to modify the color of the adhesive, and hence the resulting card form. The colorant can be any color desired, and may be a single colorant, or may be formed by mixing two or more colorants. The colorant may be mixed with the adhesive and remain under the film layers 77, 78. An example of a suitable adhesive and colorant combination that may be used is adhesive No. PN 3759K (from H. B. Fuller Co. of St. Paul, Minn.) mixed with the colorant No. 20CA2342 Hidacid Azure Blue Liquid 50% (made by Noveon Hilton Davis, Inc. of Cincinnati, Ohio). Another example of an adhesive/colorant combination that may be used is Orcobond Red 8SBLWN (available from Organic Dyestuffs Corporation, East Providence, R.I.). Thus, FIGS. 7 and 8 illustrate one embodiment of a card form that is designed to help solve the problem of being able to readily see the edges of the card form. This edge perception is needed for removal of a laminated or perforated card form from the sheetstock. The problem of edge perception may be solved by various modifications. In some approaches, these modifications may be used together.

The first modification that may be made is to use an adhesive to which colorant has been added, as described above. In one processing approach, a laminated sheetstock is produced by unwinding a roll of pressure sensitive adhesive tape and nipping this to a paper web. Thus, in a modified processing approach, a roll of plastic film may be coated with an adhesive to which colorant has been added in an inline process, and then the adhesive and film combination is laminated to a paper web, or base sheet.

The second modification that may be made concerns the die cutting/perforating process. In this step, the excess film is removed as the card shape is perforated, leaving a clear or colored film only on the card portion of the sheetstock. The adhesive does not stay on the sheet (except under the plastic film 72, 73) because it is a slow acting adhesive, or a pressure sensitive adhesive and it is only pressed on over the card form areas. The edge of the film layer may then be felt or observed as the card form has a greater thickness than the surrounding base sheet.

These two modifications may be used in conjunction with one another. In an embodiment using both modifications, the colored card edges of film layers 77, 78 are clearly defined from the background sheet 71 due to the colorant in the adhesive. The improved edge definition assists individuals, including those with poor eyesight, to more easily find the edge of the card form for removal from the sheetstock. In various embodiments, the film layer may be sufficiently clear or translucent to enable the colored adhesive to be seen through the film layer.

In addition, in some instances the film that is laminated to the sheet stock may have a coating applied to it to improve the film's receptivity to ink (including toner based ink). A colorant may be added to the coating prior to application of the coating to the film. This forms a colored layer on the external surface of the film.

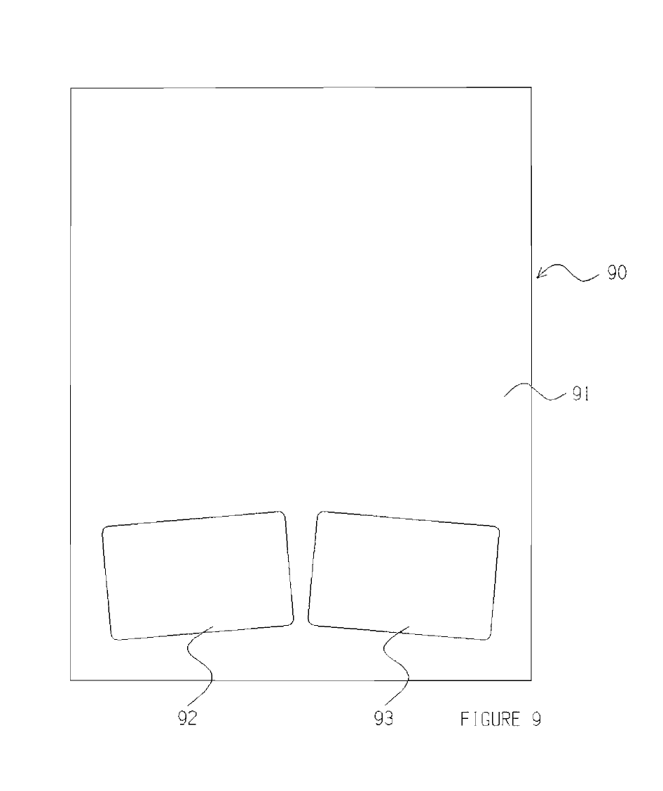

FIG. 9 shows a top view of one embodiment of a sheetstock including card forms. Sheetstock 90 includes a base sheet 91, and one or more card forms 92, 93 which are formed by perforations in the base sheet 91.

The approach illustrated in FIG. 9 is designed to assist in solving problems associated with card copy quality. Card copy quality may be an issue due to the fact that the base sheet 91 is typically made from paper that has a grain to it. The paper grain always goes in one direction (generally down web), and the paper responds differently when folded or cut in the direction of the grain (“with the grain”), than when folded or cut across the direction of the grain (“across the grain”). Generally, the paper fibers are easily spread apart with a knife or blade when cutting with the grain, and very little fiber is actually cut. However, when cutting across the grain, most of the fiber must be cut and not just spread apart or separated. Therefore, cutting across the grain is generally much more difficult and requires much more force than cutting with the grain. This difficulty may cause the base sheet to become distorted. This distortion can cause feeding, jamming, and imaging issues in the xerographic process.

In xerography, an electrical charge holding the toner in the shape of the image is placed on a thin film belt. This belt then transfers the toner to the substrate being imaged. The belt must come into intimate contact with the substrate for the transfer to occur. If the belt does not come in continuous, intimate contact with the substrate, a void, or deletion, will occur in the final copy. The aforementioned distortion in the sheetstock or base sheet that may occur during against the grain cutting or perforation may cause the belt to lose intimate contact with the substrate at times, and a deletion will occur.

FIG. 9 illustrates an approach to assist in providing a solution to the problem of voids or deletions. The illustrated approach changes the direction of the die cutting or perforations. Rather than having a rectangular card form (or rectangular shaped area) with multiple straight edges cut or perforated with each edge at 0 degrees or 90 degrees relative to the grain direction, the card forms 92, 93 may be cut with a bias relative to the grain. In one embodiment, card forms 92, 93 may be cut or perforated on a bias, such that each straight edge of the rectangular shaped area is at an angle of 0 degrees to about 75 degrees relative to the grain direction of the base sheet. The use of bias minimizes the “with the grain” and “across the grain” distortions. Using a bias, each edge requires more nearly the same amount of pressure to cut or produce the perforations, minimizing the grain effect. Minimizing the grain effect reduces or eliminates voids or deletions that may occur in printing the card forms, making the final copy complete and legible more frequently. In addition, the appearance may be more even and attractive with consistent print darkness and crisper looking printing. In various embodiments, each straight edge of a shaped area may be positioned to form an angle relative to the grain direction of from about 0 degrees to 75 degrees, or from about 0 degrees to 60 degrees, or from about 0 degrees to 45 degrees, or from about 15 degrees to 75 degrees, or approximately 45 degrees relative to the grain direction.

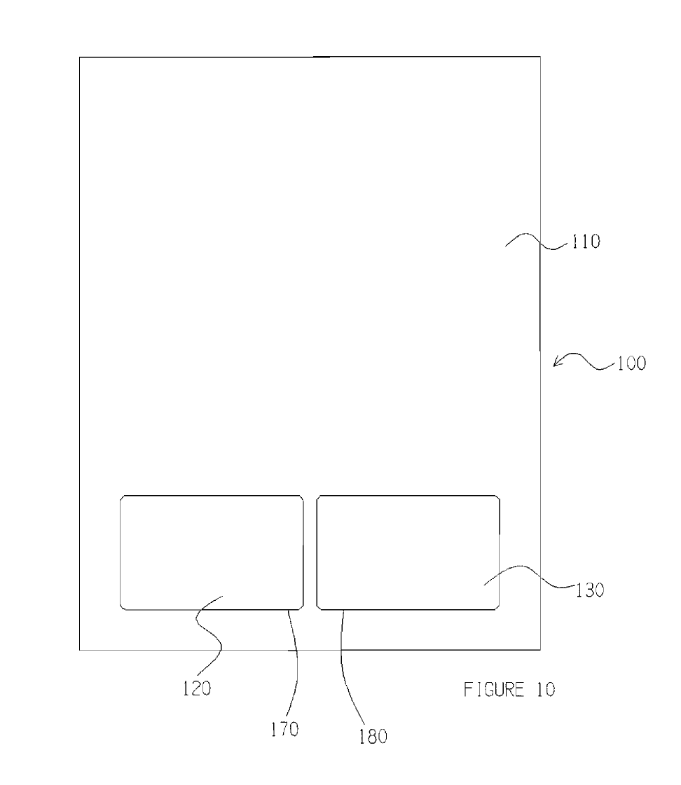

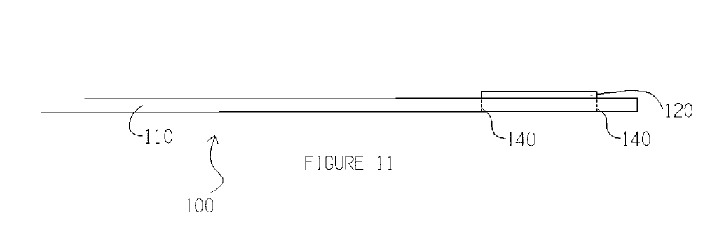

FIG. 10 shows a top view of one embodiment of a sheetstock including card forms. FIG. 11 shows a side view of the sheetstock of FIG. 10. These figures illustrate a sheetstock 100 including a base sheet 10 having card forms 120, 130. The card forms 120, 130 include film layers 170, 180 which are positioned on the base sheet 110 over an area defined by perforations 140 through the base sheet 110. In some embodiments, film layers can be laminated on both sides of the sheet.

The sheetstock 100 may be cut using a die cutting process to produce integrated card forms 120, 130 including a portion of a base sheet 110 and film layers 170, 180. Thus, the die cutting process cuts both the base sheet 110 and the film layers 170, 180 to form the card form. However, cutting through the film layers may leave nicks or cuts on the edge of the card form produced. Due to the nature of the die cutting process that cuts the cards, perforating the paper and film, there may be hundreds of these nicks or cuts formed in the edges of the film on the perimeter of the card. Each nick or cut creates a weak point where the card can easily be torn or delaminated. If the card is removed successfully it may still be subject to tearing during normal use because of the nicked edges. Full or partial delamination, or separation of the film from the card, may negate much of the value of the film layer, leading to the loss of information and/or destruction of the card.

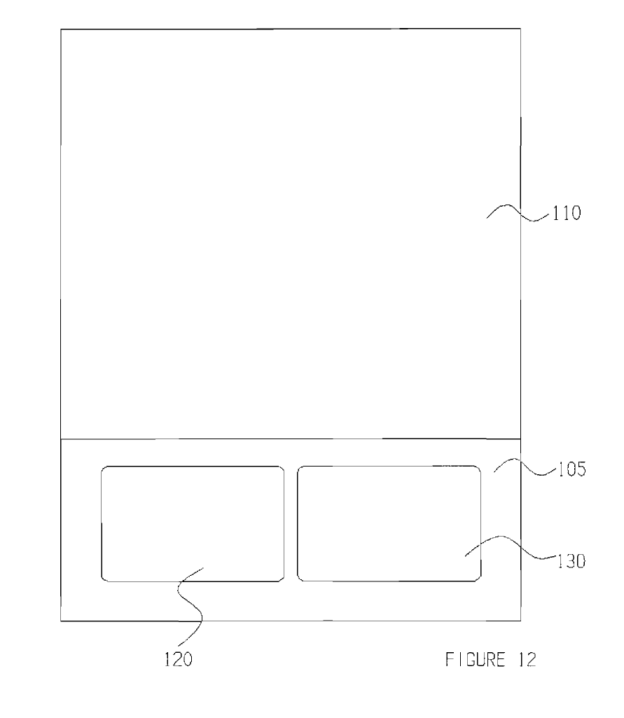

FIG. 12 shows a top view of the sheetstock of FIG. 10 during production. As shown in FIG. 12, during production of a sheetstock, a film layer 105 is applied to the base sheet 110 in the area of the card forms 120, 130 and to the surrounding area.

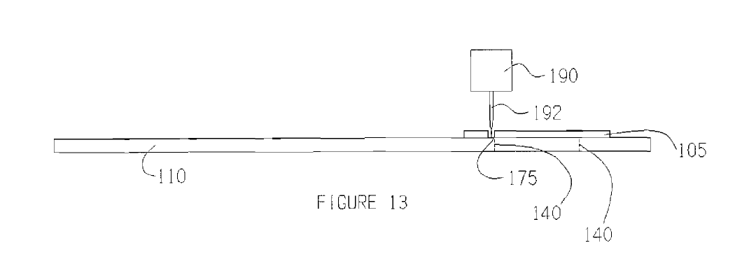

FIG. 13 shows a side view of the sheetstock of FIG. 12 being laser cut. As shown, the film layer 105 is cut or melted by using a laser 190 (such as LPM300, available from LasX Industries Inc., White Bear Lake, Minn.; or models available from Coherent Lasers, Santa Clara, Calif.; or Synrad, Inc., Mukilteo, Wash.) to cut the film layer 105 using a laser beam 192. The laser 190 may be manipulated in such a way that the laser beam 192 will cut the film layer 105 without cutting the paper base sheet 110 beneath the film layer. As the heat of the laser beam 192 cuts or melts the film layer 105, the resulting edges 175 in the card forms are smooth. These smooth edges 175 are very tear resistant, unlike the nicked edges of previous cutting methods that use a steel perforating die. In one embodiment, the film layer 105 may be cut with a galvanometer controlled laser beam.

Referring again to FIG. 10, all of the film layer 105 is removed from the base sheet 110 that is not over the shaped areas (e.g. over the area card forms 120, 130). The removal of the excess film matrix leaves film layers 170, 180. The film removal is improved by the fact that the laser beam cuts a clean edge on the film without the small ties found on conventional perforated forms. The clean cutting and smooth edge assists in the removal of the excess film from around the card forms 120, 130 leaving film layers 170, 180 only on the card forms. The film layer on the card forms may be securely adhered using time, pressure, heat, light, or other method to securely affix the film layers on the card forms.

In one embodiment, a sheetstock may be formed having film layers on both sides of the sheetstock. Using a process similar to that described above, the sheet stock can have film layers applied to both sides, where the film on one side has been cut in a shape of an identification card or other promotional material, and the film on the other side has also been cut in the same shape to a tolerance of + or − 0.012″. The cutting of one or both sides may be done using a die cutting process, laser cutting, or other method. The card forms may also have perforations that penetrate the base sheet in the same shape with the same or similar tolerance.

In one embodiment, a film layer will be applied to one surface of a base sheet. Then, the base sheet and film layer will be die cut to form the final shape of the card form. Then, a second film layer will be applied to a second surface of the base sheet, and the second film will then be cut by a laser beam to form a card form having the final desired shape, with a film layer on each side. Alternatively, the card forms may be die cut prior to application of the one or more film layers. In some embodiments where the card form is die cut prior to application of any film layer, each film layer may be laser cut as described above. In one embodiment, the cutting of the film on the other side of the sheet may use a registration mark placed on the sheet during an earlier step (such as during die cutting) to determine cutting location.

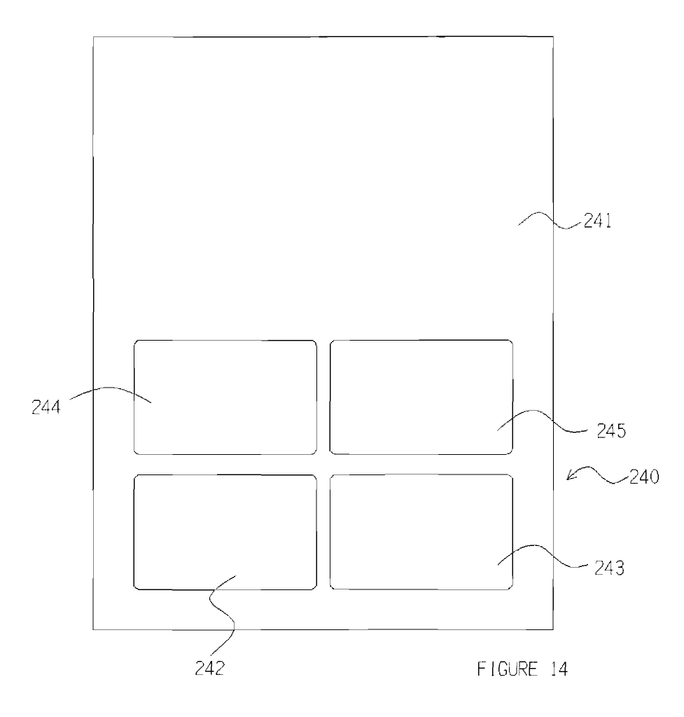

FIG. 14 shows a top view of one embodiment of a sheetstock including multiple card forms. Sheetstock 240 includes a base sheet 241, and may include any features of any sheetstock discussed above together with card forms 242, 243, 244, 245.

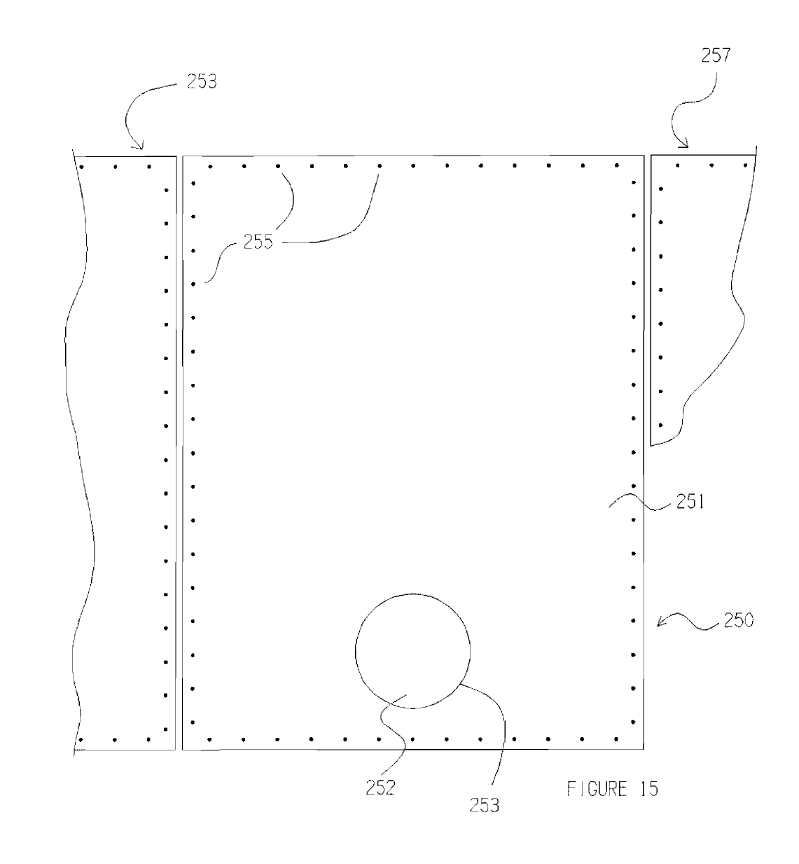

FIG. 15 shows a top view of one embodiment of a sheetstock including a card form having a circular shape. Sheetstock 250 includes a base sheet 251 and a circle shaped card form 252, and also includes a film layer 253 over the circular shape of the card form 252. Sheetstock 250 also includes a number of embossment dots 255 that run around all four edges. These embossment dots have a height (or depth) approximately equal to the thickness of the film layer 253 used. FIG. 15 also shows adjacent sheetstock pages 256, 257. As shown, the embossment dots on these pages 256, 257 are offset from the embossment dots 255 on sheetstock 250. When the pages are stacked, the embossment dots do not nest together. Thus, the embossment dots function to separate the pages and create more uniform stacking when the pages are stacked together. These benefits result from the effects of the offset together with the embossment height used. Sheetstock 250 may also include any features of any sheetstock discussed above.

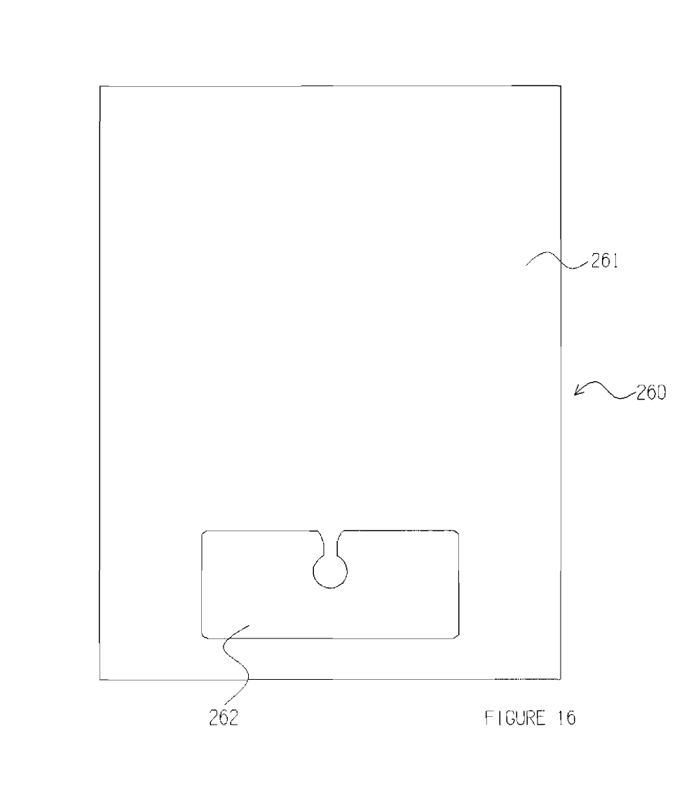

FIG. 16 shows a top view of one embodiment of a sheetstock including a card form in the shape of a hanging tag. Sheetstock 260 includes a base sheet 261 and a hanging tag shaped card form 262, and may also include any features of any sheetstock discussed above

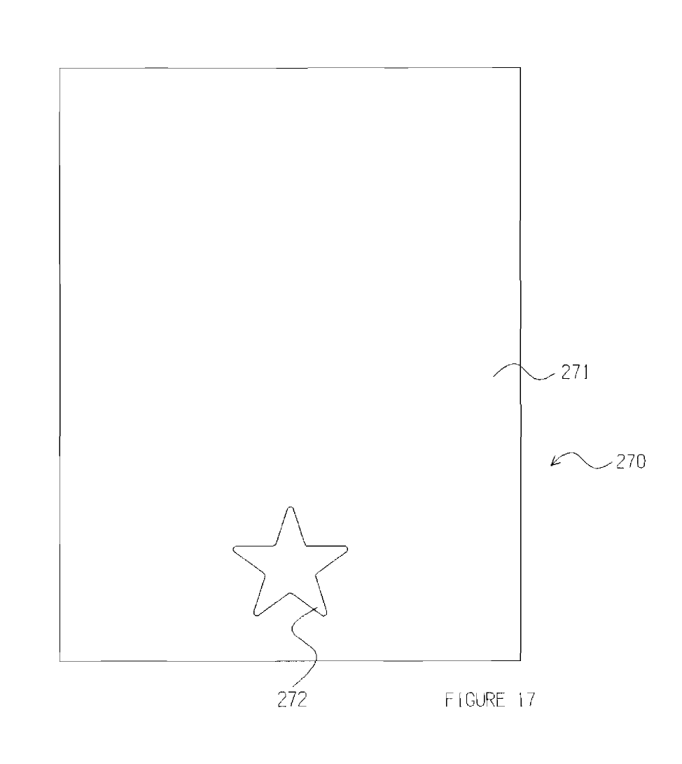

FIG. 17 shows a top view of one embodiment of a sheetstock including a card form having a star shape. Sheetstock 270 includes a base sheet 271 and a star shaped card form 272, and may also include any features of any sheetstock discussed above

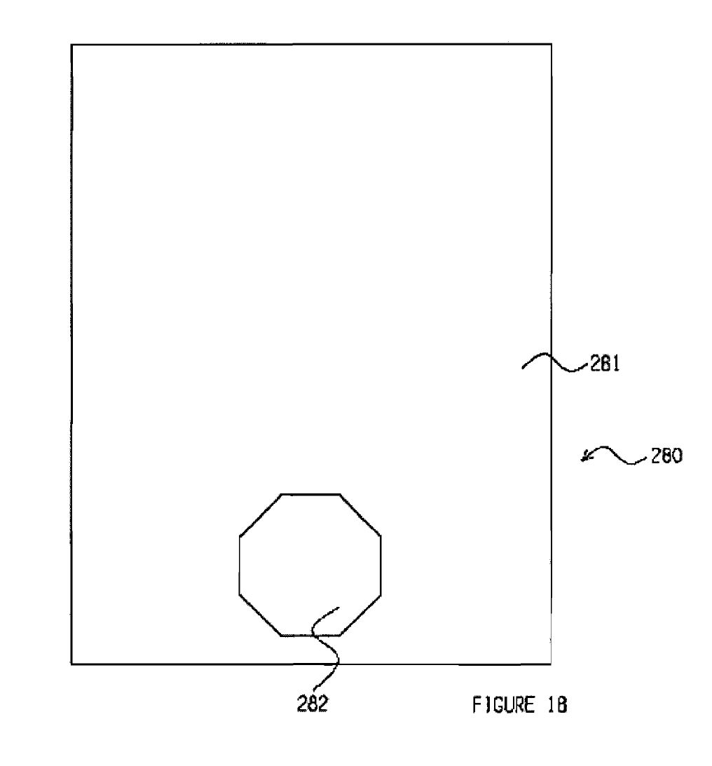

FIG. 18 shows a top view of one embodiment of a sheetstock including a card form having an octagon shape. Sheetstock 280 includes a base sheet 281 and an octagon shaped card form 282, and may also include any features of any sheetstock discussed above

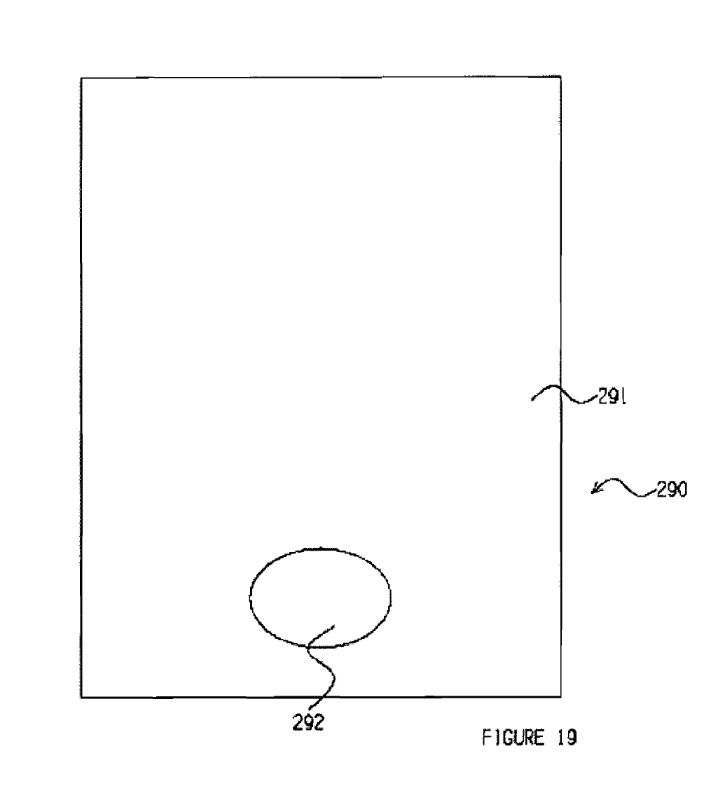

FIG. 19 shows a top view of one embodiment of a sheetstock including a card form having an oval shape. Sheetstock 290 includes a base sheet 291 and an oval shaped card form 292, and may also include any features of any sheetstock discussed above.

As illustrated, the card forms may have a wide range of shapes and a wide range of sizes. Therefore, a wide range of identification cards or other promotional material may be produced. For example, the shapes may include shapes having less than 4 sides, more than 4 sides, curved sides, rectangular or square shapes, regular polygon and irregular polygon shapes, and may have other shapes including silhouette shapes or a hanging tag shape.

In addition, any of these FIGS. 14-19 may include any other features described above, such as embossments, raised areas, raised bumps, film layers, adhesives including colorant, etc. In addition, the described sheetstock may be processed using any of the processes described above, including die cutting or perforation, laser cutting, etc.

The combination of one or more of the features, attributes, and approaches described above may be used to produce an integrated card or other promotional material that solves significant problems with current integrated laminated ID card products. In one approach, for example, the removal of excess weight and thickness of the film layer may allow the card form to process better through the printing process without skewing or mis-registering. In another approach, for example, smooth film edges on the card form edges (rather than being nicked or cut) produces a product having better tear and delamination resistance during both removal from the form and during normal consumer use.

### EXAMPLES

### Example 1.

A process for forming a card form in a sheetstock having a film layer on each side of a base sheet in a shaped area was conducted using the following steps:

1. 90 Pound Index Paper was unwound from a roll.

2. A PET film 0.00075″ in thickness and having a 6″ width was unwound from a roll and coated with adhesive No. PN 3759K at a wet thickness of 0.0004″. The adhesive film was then dried in an oven at 250° F.

3. The adhesive film was then applied to the top of the paper web in a continuous strip.

4. A small raised area of a rotary steel die was coated with ink using a Lincoln Coder and a model 3076 Porelon ink wheel.

5. The rotary steel die (slit over perf die) was used to cut through the film and into the paper, defining a shaped area.

6. At the same time that the shape was defined, a second feature on the steel die plate (a small raised area) printed a dot, or registration mark, on the paper web.

7. The excess film (not including the cutout portion) was removed from the top of the web using a matrix rewinder.

8. The paper web was turned over.

9. A second PET film, also 0.00075″ in thickness and having a 6″ width, was unwound from a roll and coated with adhesive No. PN 3759K at a wet thickness of 0.0004″. The second adhesive film was then dried in an oven at 250° F.

10. The second adhesive film was applied to the top of the paper web (which was the bottom before being turned over) in a continuous strip.

11. A camera, looking at the paper web, used the dot that was printed on the paper web as a position indication to indicate the location for laser cutting of the film layer.

12. The laser beam was used to cut the second film layer, in a shape corresponding to the shaped area.

13. The excess second film (not including the cutout portion) was removed from the top of the web using a matrix rewinder.

14. The paper was cut into individual sheets, measuring approx. 8½″×11″.

### Example 2.

The steps of Example 1 were followed with the following additional step:

1A. Colorant No. 20CA2342 Hidacid Azure Blue Liquid 50% was added to adhesive No. PN 3759K using a ratio of one ounce of colorant to 10 gallons of adhesive, prior to applying the adhesive in steps 2 and 9.

### Example 3.

A process for forming a card form in a sheetstock having a film layer on each side of a base sheet in a shaped are was conducted using the following steps:

1. 90 Pound Index Paper was unwound from a roll.

2. Following unwinding of the roll, the paper was die cut (perforated) by means of a rotary steel die to form a perforated shape.

3. At the same time as the paper was being die cut, a small raised portion on the die cutting cylinder was being coated with ink and a small dot or registration mark was being printed on the paper.

4. A PET film 0.00075″ in thickness and having a 6″ width was unwound from a roll and coated with 0.0002″ of HB 29 Ultra Violet curable adhesive (made by Radcure Inc., Fairfield, N.J.)

5. The coated PET web was then slit into two equal strands 3″ wide.

6. The first strand was directed onto the first side of the paper web covering the area previously perforated by the steel die.

7. A camera registration system, using the printed dot as reference, provided positioning information to a laser system. A laser beam was steered by a high speed galvanometer to cut the film in approximately the same shape as the perforated shape from step 2. The excess film, not including the cut out portion, was removed from the paper web and rewound by a matrix rewinder.

8. The paper web was passed under a Model F300S 300 watt Ultra Violet lamp (Fusion Systems, Gaithersburg, Md.) exposing the adhesive to UV light and the adhesive was cured.

9. The web was turned over and steps 6 through 8 were repeated on a second side of the paper web using the second coated PET strand.

10. The paper web, with defined and laminated portions attached to both sides, traveled through a rotary embossing unit with a repeat length of 17″. The embossing unit contains two cylinders, one with raised portions (male), and one with recessed portions (female) that align with each other as they rotate. The paper web was passed between these two cylinders and was pushed by the male feature into the female feature, causing multiple embossments to occur on the surface of paper web. The embossments were circular in shape, having a diameter of 0.04″ and a height of 0.0015″. This height (or depth) of the embossments was approximately equal to the combined height of the film layers used. The embossments were spaced approximately ¾″ apart in a rectangular shape approximately 10½″ by 8″ on the first half the cylinders. On the second half of the cylinders, similar male and female embossment features were positioned 1/16 farther apart than on the first half of the cylinders (e.g., 13/16 apart).

11. The paper web, with defined and laminated portions attached to both sides and embossments approximately every 8½, was then cut in a standard press sheeter to a size of 8½ long by 11″ wide. The cutting was done in a position that caused the embossments to stack on top of one another with every other sheet having embossments offset by 1/16″. The offset embossments stacking thereby eliminating nesting of the embossed features, and caused the non-laminated portion of the sheets to remain approximately level with the laminated portions.

A number of embodiments of the invention have been described. Nevertheless, it will be understood that various modifications may be made without departing from the spirit and scope of the invention. For example, any of the features of the various embodiments discussed may be combined in various combinations on a single sheetstock. Moreover, any of these features may be used in various combinations for products that are produced using sheet fed, roll fed, or other types of equipment as well as various sheet or roll sizes or weights of paper or plastic. Accordingly, other embodiments are within the scope of the following claims.

What is claimed is:

1. A sheetstock, comprising:
a base sheet including a cut or perforated shaped area that is separable from the base sheet; and
a film layer adhered to and confined to a top surface of the shaped area.

2. The sheetstock of claim 1, further comprising an area outside the shaped area on a surface of the base sheet having a height at least about the same as a height of the film layer.

3. The sheetstock of claim 2, wherein the area outside the shaped area comprises an embossment in the base sheet surface.

4. The sheetstock of claim 1, wherein the film layer is formed in the shape of the shaped area by laser cutting the film layer.

5. The sheetstock of claim 1, wherein the sheetstock further comprises a second film layer adhered to and confined to a bottom surface of the shaped area, and wherein the second film layer is formed in the shape of the shaped area by laser cutting the second film layer.

6. The sheetstock of claim 1, wherein the film layer is adhered to the sheet using a colored adhesive.

7. The sheetstock of claim 1, wherein the shaped area has more than 4 sides.

8. The sheetstock of claim 1, wherein the shaped area has the shape of a hanging tag.

9. A process for forming a card form in a sheetstock, comprising:
cutting or perforating a base sheet to form a shaped area that is separable from the base sheet;
adhering a film layer to a surface of the base sheet; and
cutting or perforating a film layer to confine the film layer to the shaped area to form a card form in a sheetstock

10. The process of claim 9, wherein the film layer is cut using a laser beam.

11. The process of claim 9, further comprising using an adhesive including a colorant to adhere the film layer to the base sheet.

12. The process of claim 9, further comprising adhering a second film layer to another surface of the base sheet, and cutting or perforating the second film layer to confine the second film layer to the shaped area using a laser beam.

13. The process of claim 9, further comprising embossing a first area of the base sheet to have a height at least about the same as the film layer.

14. The process of claim 13, further comprising embossing a second area that is offset from the first embossed area such that when a sheetstock including the first embossed area is stacked with a sheetstock including the second embossed area the embossed areas do not nest together.

15. The process of claim 14, wherein the base sheet is cut to produce a number of sheetstocks.

16. A process for forming a card form in a sheetstock, comprising:
applying a first film layer to a first surface of a base sheet;
cutting or perforating the film layer and base sheet to form a shaped area that is separable from the base sheet while also placing a registration mark;
applying a second film layer to a second surface of the base sheet; and
using the registration mark for positioning to cut the second film layer.

17. The process of claim 16, further comprising removing the first film layer not within the shaped area.

18. The process of claim 16, further comprising removing the second film layer not within the shaped area.

19. The process of claim 16, wherein cutting or perforating and placing a registration mark is done using a die.

20. The process of claim 16, further comprising embossing an area of the base sheet to have a height at least about the same as the total height of the film layers.
